(19) United States
(12) Patent Application Publication
(10) Pub. No.: US 2006/0077291 A1
(43) Pub. Date: Apr. 13, 2006

(54) Image signal converter and method of converting image signal

(75) Inventor: Kyung-Il Yun, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/150,263

(22) Filed: Jun. 13, 2005

(30) Foreign Application Priority Data
Oct. 13, 2004 (KR) 2004-81837

(51) Int. Cl. H04N 7/01

(52) U.S. Cl. 348/446

(57) ABSTRACT

An apparatus and method for converting an image signal for converting a progressive scan image signal having given number of frames per given time into an interlaced scan image signal having different number of frames per the given time from the progressive scan image signal, the converting method involving separating fields from each frame of the progressive scan image signal and storing the fields; comparing each of the stored fields and detecting whether a picture switch occurs between the frames of the progressive scan image signal based on whether there is a movement between the compared fields; and controlling the number of the fields extracted per frame from two sequential frames in which the picture switch occurs, whereby the fields separated from each of the two sequential frames form each of the different frames of the interlaced scan image signal.

### CROSS-REFERENCE TO RELATED APPLICATION

This application claims the benefit under 35 U.S.C. §119(a) of Korean Patent Application No. 2004-0081837, filed on Oct. 13, 2004, in the Korean Intellectual Property Office, the entire disclosure of which is incorporated herein by reference.

### BACKGROUND OF THE INVENTION

1. Field of the Invention

The present invention relates to an image signal converter and a method of converting an image signal. More particularly, the present invention relates to an image signal converter and a method of converting an image signal capable of improving quality of a picture by minimizing the losses due to signal distortion caused by a picture switch when a progressive scan image signal is converted into an interlaced scan image signal.

2. Description of the Related Art

There are two ways of scanning in a picture display device. One is interlaced scan process, and the other is progressive scan process.

The interlaced scan process is typically employed in conventional televisions (TVs), and it divides each image frame into two fields and displays the two fields alternately and sequentially. The two fields are referred to top and bottom fields, upper and lower fields, or odd and even fields, and the like.

The progressive scan process is employed in a computer monitor, a digital TV, and the like, and it displays the image frame by the frame one at a time like projecting a film on a screen.

Therefore, in order for an interlace scan display device to process a progressive scan image signal, the interlaced scan display device needs therein a converter, which converts the progressive scan image signal into an interlaced scan image signal to process the progressive scan image signal normally. PS8356/US (2004-81837)

Basically, to display a film image signal, the progressive scan process must be applied at the rate of twenty four frames per second. When the film image signal is displayed in the display device for the interlaced scan image signal process, the film image signal is converted into the interlaced scan image signal with sixty fields per second in a NTSC system or fifty fields per second in a PAL system.

The 3:2 or 2:3 pull-down types and a 2:2 pull-down type are employed to form an NTSC interlaced scan image signal and a PAL interlaced scan image signal, respectively.

An example of the 2:3 pull-down type converting the film image signal into the NTSC interlaced scan image signal is as follows.

As shown in FIG. 1, frames of the film image signal are input sequentially. Two fields, Fₙ^{T} and Fₙ^{B} fields, are extracted from Fₙ frame of the film image signal. F₊₁^{T} and Fₙ₊₁^{B} fields are extracted from Fₙ₊₁ frame, and the Fₙ₊₁^{T} field is re-extracted, so that the Fₙ₊₁ frame is converted into the three fields. Subsequently, two fields, Fₙ₊₂^{B} and Fₙ₊₂^{T} fields, are extracted from Fₙ₊₂ frame. Fₙ₊₃^{B} and Fₙ₊₃^{T} fields are extracted from Fₙ₊₃ frame and the F₊₃^{B} field is re-extracted, so that the Fₙ₊₃ frame is converted into the three fields.

Like the above, four frames of the film image signal are converted into the interlaced scan image signals with the rates of the respective top/bottom fields of 2:3:2:3(or 3:2:3:2). By adding one field into every other film frame, four film frames can be changed to five video frames, where a combination of top and bottom fields forms one video frame.

In FIG. 1, when a picture switch occurs between the Fₙ and Fₙ₊₁ frames or between the Fₙ₊₃ and F₊₄ frames, there is no problem. However, the picture switch occurring between the Fₙ₊₁ and Fₙ₊₂ frames or between the Fₙ₊₂ and Fₙ₊₃ frames causes the following problem.

In FIG. 1, if the picture switch occurs between the Fₙ₊₁ and Fₙ₊₂ frames or between the Fₙ₊₂ and Fₙ₊₃ frames, the quality of the picture deteriorates due to a signal distortion occurring while processing the interlaced scan image signal because the Fₙ₊₁^{T} and Fₙ₊₂^{B} fields (or the Fₙ₊₂^{T} and Fₙ₊₃^{B} fields), forming one frame, do no correspond with each other.

### SUMMARY OF THE INVENTION

Accordingly, it is an aspect of the present invention to provide an image signal converter and a method of converting an image signal capable of improving quality of a picture by minimizing the signal distortion caused by a picture switch when a progressive scan image signal is converted into an interlaced scan image signal.

The foregoing and/or other aspects of the present invention are also achieved by providing a method for converting a progressive scan image signal having a given number of frames per a given time into an interlaced scan image signal having a different number of frames per the given time from the progressive scan image signal, the converting method comprising the steps of separating fields from each frame of the progressive scan image signal and storing the fields; comparing each of the stored fields and detecting whether a picture switch occurs between the frames of the progressive scan image signal based on whether there is movement between the compared fields; and controlling the number of fields extracted from two sequential frames in which the picture switch occurs, by the frame, whereby the fields separated from each of the two sequential frames form the different frames of the interlaced scan image signal.

According to the embodiment of the present invention, the step of controlling the number of the fields comprises controlling a last field extracted from a prior frame in the two sequential frames to be a bottom field.

According to the embodiment of the present invention, the step of controlling the number of the fields comprises determining whether a last field, extracted from an immediately previous frame of the two sequential frames, is a bottom field; converting the prior frame in the two sequential frames into two fields and the latter frame into three fields if the last field is a bottom field; converting the prior frame in the two sequential frames into three fields and the latter frame into two fields if the last field is not a bottom field.

The foregoing and/or other aspects of the present invention are also achieved by providing an image signal converter for converting a progressive scan image signal having given number of frames per given time into an interlaced scan image signal having different number of frames per the given time from the progressive scan image signal, the image signal converter comprising a field storage unit for storing therein fields separated from each frame of the progressive scan image signal; a picture switch detection unit for comparing each of the stored fields in the field storage unit and detecting whether a picture switch occurs between frames of the progressive scan image signal depending on whether there is movement between each of the compared fields; and a field extraction unit for controlling the number of fields extracted from two sequential frames in which the picture switch occurs, by the frame, whereby the stored fields corresponding to each of the two sequential frames form each of the different frames of the interlaced scan image signal.

According to the embodiment of the present invention, the field extraction unit designates a last field extracted from a prior frame in the two sequential frames to be a bottom field while controlling the number of the fields.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 shows a conventional process of converting an image signal,

FIG. 2 is a block diagram of an image signal converter according to an embodiment of the present invention,

FIG. 3 is a flow chart showing a method of converting an image signal according to an embodiment of the present invention,

FIG. 4 shows a process of converting an image signal according to an embodiment of the present invention,

FIG. 5 shows a process of converting an image signal according to an embodiment of the present invention,

FIG. 6 shows a process of converting an image signal according to an embodiment of the present invention.

Throughout the drawings, it should be understood that like reference numbers refer to like features, structures and elements.

### DETAILED DESCRIPTION OF THE EXEMPLARY EMBODIMENTS

Reference will now be made in detail to exemplary embodiments of the present invention, examples of which are illustrated in the accompanying drawings.

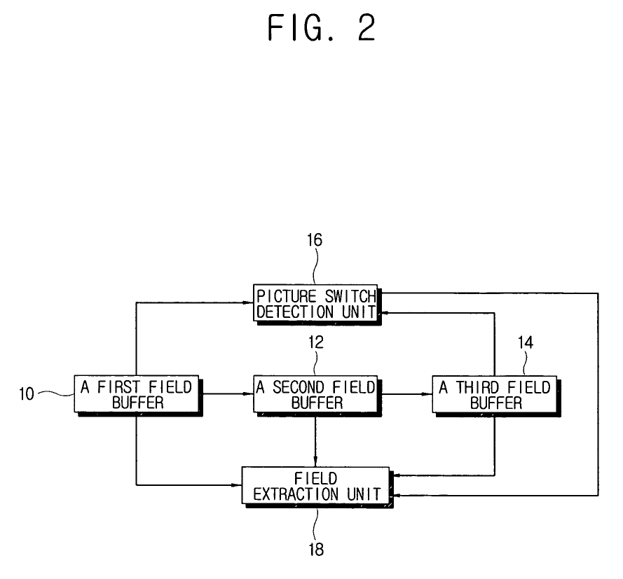

FIG. 2 is a configuration block diagram of an image signal converter for converting a progressive scan image signal of the progressive scan process into an interlaced scan image signal of the interlaced scan process according to an embodiment of the present invention. As shown in FIG. 2, the image signal converter comprises first to third field buffers 10, 12 and 14, a picture switch detection unit 16, and a field extraction unit 18.

Although not shown in FIG. 2, the image signal converter further comprises a field conversion unit, which converts each frame of the progressive scan image signal (hereinafter referred to as “progressive scan frame”) into top and bottom fields and outputs the fields to the respective first to third field buffers 10, 12 and 14 sequentially according to time.

The first to third field buffers 10, 12, and 14 store and output the fields converted by the field conversion unit sequentially according to time. In the first field buffer 10 are stored the fields of an immediately previous progressive scan frame (n), in the second field buffer 12 are stored the fields of a current progressive scan frame (n+1), and in the third field buffer 14 are stored the fields of a next progressive scan frame (n+2).

The picture switch detection unit 16 compares the fields stored in the first field buffer 10 and the third field buffer 14 with the current fields stored in the second field buffer 12, detects whether or not a picture switch occurs based on whether or not there is movement between the compared fields, and outputs a picture switch detection signal corresponding to the movement detection to the field extraction unit 18.

The field extraction unit 18 controls the number of fields to be transmitted according to each progressive scan frame if it determines, by being provided the picture switch detection signal from the picture switch detection unit 16, that the picture switch is detected, so that the fields converted from each of the two sequential progressive scan frames in which the picture switch occurs form their respective different frames of the interlaced scan image signal in the NTSC system (hereinafter referred to as “NTSC interlaced scan frames”). While controlling the number of the fields to be transmitted according to each progressive scan frame, the progressive scan image signal of 24 frames per second has to be converted into the interlaced scan image signal of 60 fields per second in the NTSC system.

However, the field extraction unit 18 extracts the fields by an existing 2:3 pull-down process if it determines, by being provided the picture switch detection signal from the picture switch detection unit 16, that the picture switch is not detected by the picture switch detection unit 16.

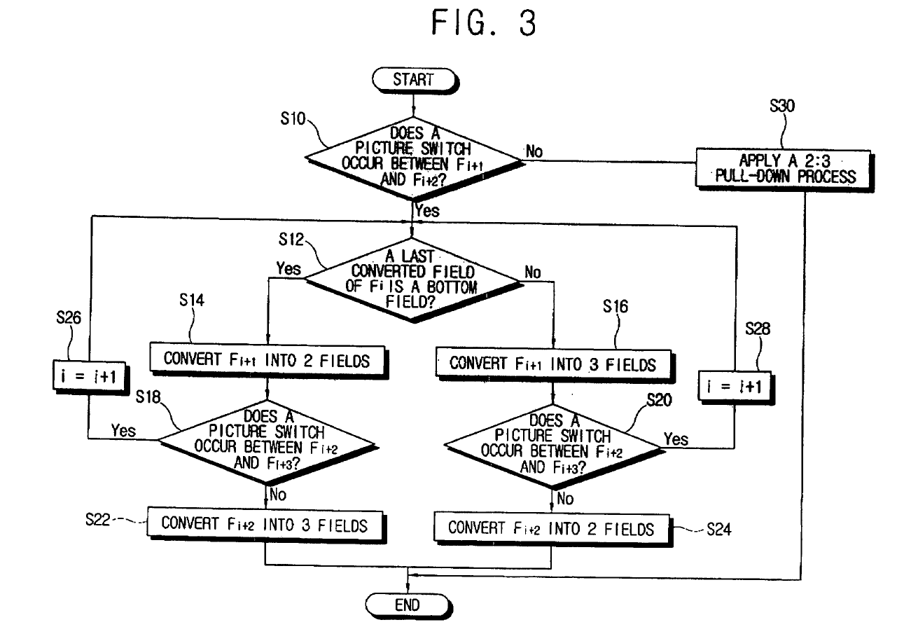

With reference to FIG. 3, a method for converting an image signal for the image signal converter according to the above configuration will now be described. In FIG. 3, i, i+1, i+2, i+3, . . . , i+n in frames Fᵢ, Fᵢ₊₁, Fᵢ₊₂, Fᵢ₊₃ . . . , Fᵢ₊ₙ, represent a time sequence.

A film image signal as the progressive scan image signal is sequentially input according to time. In addition, each progressive scan frame of the film image signal is converted into the top and bottom fields by the field conversion unit (not shown). The converted fields are stored in the first to third field buffers 10, 12, and 14. The picture switch detection unit 16 compares the fields stored in the first field buffer 10 and the third field buffer 14 with the current fields stored in the second field buffer 12, and detects whether or not a picture switch occurs.

In the case where the fields are extracted as far as the Fi frame and that the picture switch is detected between the Fᵢ₊₁ and the Fᵢ₊₂ by the picture switch detection unit 16 at operation S10, the field extraction unit 18 determines whether or not a last arranged field separated from the Fᵢ frame, which is previous to the Fᵢ₊₁ frame, is the bottom field at operation S12. If the last arranged field is the bottom field, the field extraction unit 18 extracts the top and bottom fields of the Fᵢ₊₁ frame from the field buffer at operation 14 so that the two fields are separated from the Fᵢ₊₁ frame. Then, if the picture switch is not detected at operation S18 between the Fᵢ₊₂ and Fᵢ₊₃ frames, which are next to the Fᵢ₊₁ frame, by the picture switch detection unit 16, the field extraction unit 18 extracts and arranges the top, bottom, and top fields of the Fi+2 frame at operation S22 so that the Fi+2 frame is separated into the three fields. However, if the picture switch is detected between the Fi+2 and Fᵢ₊₃ frames at operation S18, the field extraction unit 18 determines whether or not the last arranged field separated from the Fᵢ₊₁ frame is the bottom field at operation S26, and repeats the above processes.

On the other hand, if the field extraction unit 18 determines the last field separated from the Fᵢ frame is not the bottom field, but is instead the top field at operation S12, the field extraction unit 18 extracts the bottom, top and bottom fields of the Fᵢ₊₁ frame from the field buffer at operation 16 so that the three fields are separated from the Fᵢ₊₁ frame. If the picture switch is not detected between the Fᵢ₊₂ and Fᵢ₊₃ frames by the picture switch detection unit 16 at operation S20, the field extraction unit 18 extracts the top and bottom fields of the Fᵢ₊₂ frame at operation S24 so that the Fᵢ₊₂ frame is separated into the two fields, top and bottom. However, if the picture switch is detected between the Fᵢ₊₂ and Fᵢ₊₃ frames at operation S20, the field extraction unit 18 determines whether or not the last arranged field separated from the Fᵢ₊₁ frame is the bottom field at operation 12, and repeats the above processes.

Also, if the picture switch does not occur between the Fᵢ₊₁ and Fᵢ₊₂ frames at operation S10, the 2:3 pull-down process is employed at operation 30.

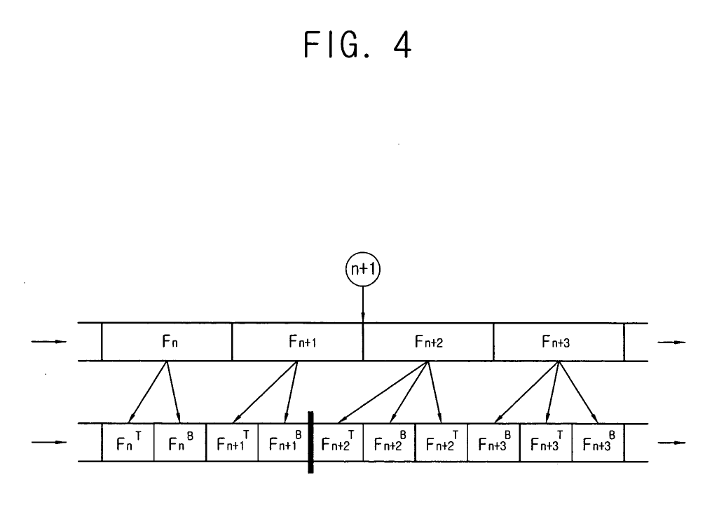

The above-described processes will now be described in more detail by referring to FIGS. 4 to 6.

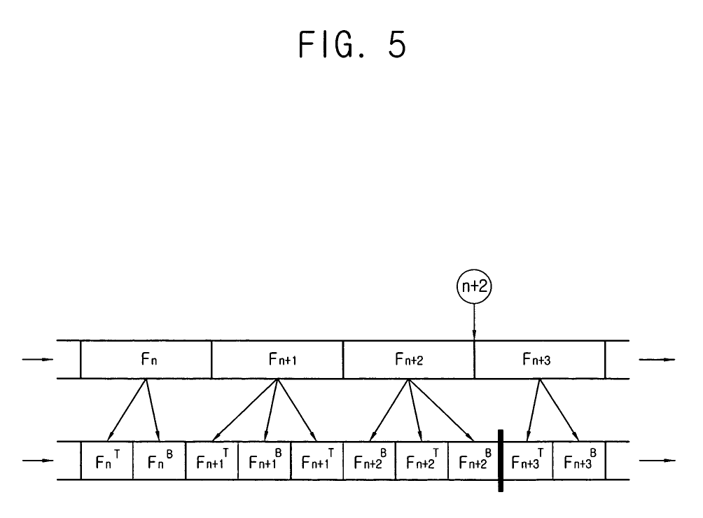

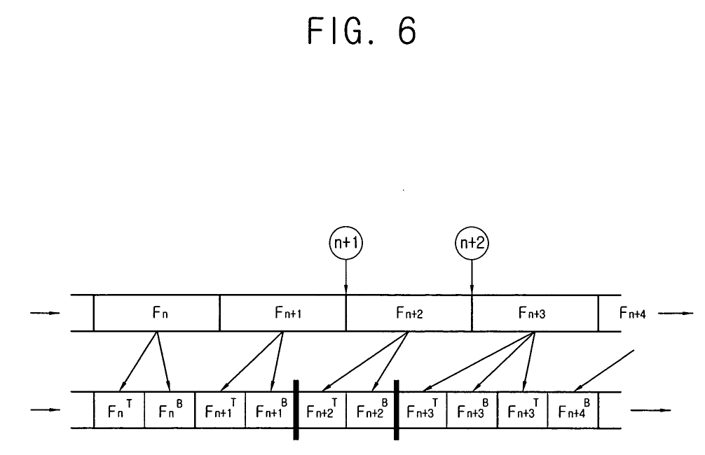

FIG. 4 shows an image signal in which the picture switch occurs between Fₙ₊₁ and Fₙ₊₂ frames, and FIG. 5 shows an image signal in which the picture switch occurs between Fₙ₊₂ and Fₙ₊₃ frames, and FIG. 6 shows an image signal in which the picture switches occur between the Fₙ₊₁ and Fₙ₊₂ frames and also between the Fₙ₊₂ and Fₙ₊₃ frames.

FIG. 4 illustrates a case where i=n in the flow chart of FIG.3.

In FIG. 4, the sequential input of each frame of a film image signal (Fₙ, Fₙ₊₁, Fₙ₊₂, Fₙ₊₃, and so on).

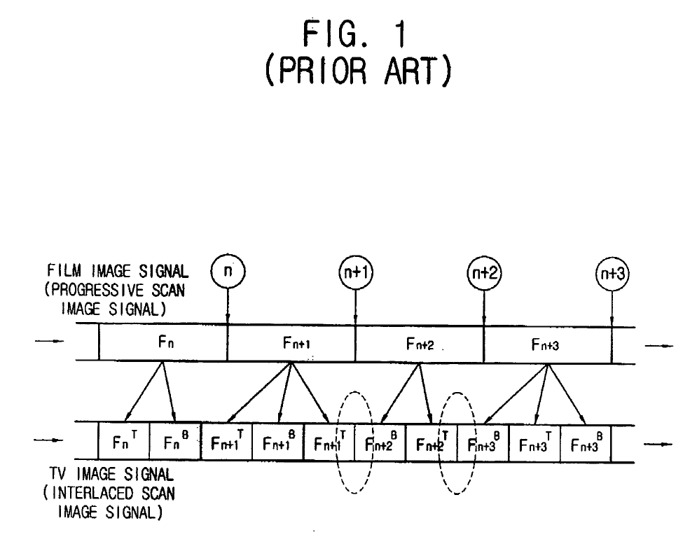

In the case where a top field (Fₙ^{T}) and a bottom field (Fₙ^{B}) are extracted from the Fₙ frame and a picture switch occurs between the Fₙ₊₁ and Fₙ₊₂ frames, but the picture switch does not occur between the Fₙ₊₂ and Fₙ₊₃ frames, a top field (Fₙ₊₁^{T}) and a bottom field (Fₙ₊₁^{B}) are extracted from the Fₙ₊₁ frame so that the Fₙ₊₁ frame is separated into the two fields. In addition, a top field (Fₙ₊₂^{T}), a bottom field (Fₙ₊₂^{B}), and the top field (Fₙ₊₂^{T}) are extracted from the Fₙ₊₂ frame so that the Fₙ₊₂ frame is separated into the three fields. Also, a bottom field (Fₙ₊₃^{B}), a top field (Fₙ₊₃^{T}), and the bottom field (Fₙ₊₃^{B}) are extracted from the Fₙ₊₃ frame as shown in FIG. 1 so that four frames of the film image signal form the ten fields, or five video frames as the NTSC interlaced scan frames.

Here, the fields in each of the 5 NTSC interlaced scan frames have a mutual connection, and the respective fields of the two sequential film frames, where the picture switch occurs, do not form the same NTSC interlaced scan frame. As shown in FIG. 1, conventionally the Fₙ₊₁^{T} and Fₙ₊₂^{B} fields, each having different picture information, form one NTSC interlaced scan frame, thereby lowering the quality of the picture. However, in embodiments of the present invention, the fields of the Fₙ₊₁ frame and the fields of the Fₙ₊₂ frame are not converted into a same NTSC interlaced scan frame but each separated into the different NTSC interlaced scan frames, so that a lowering in the quality of picture can be prevented.

FIG. 5 illustrates a case where i=n+1 in the flow chart of FIG. 3 and the sequential input of each frame of a film image signal (Fₙ, Fₙ₊₁, Fₙ₊₂, Fₙ₊₃, and so on).

In the case where a top field (Fₙ^{T}) and a bottom field (Fₙ^{B}) are extracted from the Fₙ frame and a top field (Fₙ₊₁^{T}), a bottom field (Fₙ₊₁^{B}), and the top field (Fₙ₊₁^{T}) are extracted from the Fₙ₊₁ frame and the picture switch occurs between the Fₙ₊₂ and Fₙ₊₃ frames, a bottom field (Fₙ₊₂^{B}), a top field (Fₙ₊₂^{T}), and the bottom field (Fₙ₊₂^{B}) are extracted from the Fₙ₊₂ frame so that the Fₙ₊₂ frame is separated into the three fields. In addition, a top field (Fₙ₊₃^{T}) and a bottom field (Fₙ₊₃^{B}) are extracted from the Fₙ₊₃ frame so that the F₊₃ frame is separated into the two fields. Therefore, four frames of the film image signal form ten fields, or five video frames as the NTSC interlaced scan frames.

Like FIG. 4, the fields of the Fₙ₊₂ frame and the fields of the Fₙ₊₃ frame, each having different picture information, are not converted into the same NTSC interlaced scan frame of the interlaced scan image signal, but are each separated into the different NTSC interlaced scan frames, so that the quality of picture can be improved.

FIG. 6 shows a case that the picture switches occur between the Fₙ₊₁ and Fₙ₊₂ frames and also between the Fₙ₊₂ and Fₙ₊₃ frames. As shown in FIG. 4, the Fₙ₊₁ frame is converted into two fields. Then the next Fₙ₊₂ frame is separated into two fields, and the Fₙ₊₃ frame is separated into three fields. Fₙ₊₄ frame is separated into three fields by adding one field, so that four frames of the film image signal form five NTSC interlaced scan frames.

Therefore, the respective fields of the two sequential frames in which the picture switch occurs are not converted into the same NTSC interlaced scan frame, but each field is separated into the different NTSC interlaced scan frames, so that lower picture quality can be prevented.

Although the above embodiments show examples transformed from the 2:3 pull-down process, the number of fields of the frames, where the picture switch occurs, can be controlled based on a 3:2 pull-down process.

Although only a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method for converting a progressive scan image signal having given number of frames per given time into an interlaced scan image signal having different number of frames per the given time from the progressive scan image signal, the converting method comprising the steps of:
separating fields from each frame of the progressive scan image signal and storing the fields;
comparing each of the stored fields and detecting whether a picture switch occurs between the frames of the progressive scan image signal based on whether there is movement between the compared fields; and
controlling the number of fields extracted per frame from two sequential frames in which the picture switch occurs, whereby the fields separated from each of the two sequential frames form each of different frames of the interlaced scan image signal.

2. The method of converting an image signal as claimed in claim 1, wherein the step of controlling the number of the fields comprises setting a last field extracted from a prior frame in the two sequential frames to be a bottom field.

3. The method of image signal converting as claimed in claim 1, wherein the step of controlling the number of the fields comprises the steps of:
determining whether a last field, extracted from an immediately previous frame of the two sequential frames, is a bottom field;
converting the prior frame in the two sequential frames into two fields and the other frame into three fields if the last field is a bottom field; and
converting the prior frame in the two sequential frames into three fields and the other frame into two fields if the last field is not a bottom field.

4. An image signal converter for converting a progressive scan image signal having a given number of frames per given time into an interlaced scan image signal having a different number of frames per the given time from the progressive scan image signal, the image signal converter comprising:
a field storage unit for storing therein fields separated from each frame of the progressive scan image signal;
a picture switch detection unit for comparing each of the stored fields in the field storage unit and detecting whether a picture switch occurs between frames of the progressive scan image signal depending on whether there is a movement between each of the compared fields; and
a field extraction unit for controlling the number of the fields extracted per frame from two sequential frames in which the picture switch occurs, whereby the stored fields corresponding to each of the two sequential frames form each of different frames of the interlaced scan image signal.

5. The image signal converter of claim 4, wherein the field extraction unit controls a last field extracted from a prior frame in the two sequential frames to be a bottom field while controlling the number of the fields.

6. A computer readable medium storing program code for instructing a computer to execute the steps of:
separating fields from each frame of the progressive scan image signal and storing the fields;
comparing each of the stored fields and detecting whether a picture switch occurs between the frames of the progressive scan image signal based on whether there is movement between the compared fields; and
controlling the number of fields extracted per frame from two sequential frames in which the picture switch occurs, whereby the fields separated from each of the two sequential frames form each of different frames of the interlaced scan image signal.

7. The computer readable medium as claimed in claim 6, wherein the step of controlling the number of the fields comprises setting a last field extracted from a prior frame in the two sequential frames to be a bottom field.

8. The computer readable medium as claimed in claim 6, wherein the step of controlling the number of the fields comprises the steps of:
determining whether a last field, extracted from an immediately previous frame of the two sequential frames, is a bottom field;
converting the prior frame in the two sequential frames into two fields and the other frame into three fields if the last field is a bottom field; and
converting the prior frame in the two sequential frames into three fields and the other frame into two fields if the last field is not a bottom field.
